(19) United States
(12) Patent Application Publication
(10) Pub. No.: US 2003/0110445 A1
(43) Pub. Date: Jun. 12, 2003

(54) Method and architecture for building client-server applications

(76) Inventor: Ferdouse Khaleque, Santa Cruz, CA (US)

Correspondence Address: Bradley J. Bereznak, Burgess & Bereznak, LLP, Suit 180, 800 West EI Camino Real, Mountain View, CA, 94040, US

(21) Appl. No.: 10/013,119

(22) Filed: Dec. 7, 2001

(51) Int. Cl. G06F 15/16; G06F 15/00

(52) U.S. Cl. 715/505; 709/206

(57) ABSTRACT

A system and method for building a more efficient, reliable, and scalable client-server application is provided. State information of the system is maintained in the form of cookies on the client side and as a table entry in a database on the server side. A database application may be extended to include other networked applications such as a word processor, project management and accounting software. A distributed architecture is realized which makes use of the parallel database component on the server end and provides a level of abstraction from the operating system. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### FIELD OF THE INVENTION

The present invention relates to client-server applications.

### BACKGROUND OF THE INVENTION

The Internet has grown rapidly in recent years and has now become an accepted and popular way to communicate and to conduct many types of business activities. For example, the Internet is commonly used for e-mail, searching for information (e.g., news, weather, sports, etc.), and for buying and selling goods online.

The web browser has become the software application of choice as the gateway to the Internet. A typical browser (on the client side) interacts with a server to request and retrieve information over a network (e.g., the Internet). The browser operates in a “sandbox” environment that prevents programs downloaded by the browser from having access to the clients' file system.

In operation, the browser requests a hyper-text markup language (“HTML”) page from a server. The server fulfills this request by sending this page back to the browser. Once this is done the connection is dropped and the server continues serving requested pages in response to client requests. As a result, the hyper-text transmission protocol (“HTTP”) is considered “stateless” since it does not keep track of the pages being viewed by the client. Because of the “stateless” nature of the HTTP protocol, the browser in most cases only supports the presentation of information, with the application logic wholly residing in the server.

The worldwide web has evolved from its basic concept of serving static HTML pages to providing rich, dynamic web pages and information derived from web-based databases. Many techniques have been developed to offer the dynamic content users see on their browsers using scripting languages (e.g., JavaScript) and server side programs built using PHP, C++, Java™, and active server pages.

Although there are a number of techniques available to provide the application functionality on the browser-end, building web-based client server applications has been challenging. For example, applications including “applets” are capable of being downloaded by the browser, but bandwidth restrictions limit the size of the applet that can be downloaded. Technology also exists that allows documents using Microsoft Word™, for example, to be embedded into the browser. However, this technology is proprietary. A tunneling protocol that rides on top of the HTTP where more sophisticated client-server instruction sets can be used has also been proposed. However, to date, no software is available on the market that implements this technological approach.

Creating effective web-based client-server applications has been difficult. Standard applications such as a word processor typically reside on the users' desktop. Once open, these applications load into the systems' program memory and are run “in process” (i.e., the application will respond instantaneously to any user changes while the user is adding or modifying the document). In the case of client-server systems, part or all of the application generally resides on the remote server where an “in-process” application can communicate with an “out-of-process” application on a remote server. However, for these applications to talk to each other effectively in a distributed environment requires a detailed understanding of network protocols as well as operating systems. As a result, several specifications have emerged to enable distributed technology, namely the distributed component object model (“DCOM”) used for Microsoft Windows™ and common object request broker architecture (“CORBA™”) for unix. Javascript, with its remote method invocation (“RMI”) capabilities, also provides scalable distributed software in the form of enterprise java beans (“EJB”).

Client-server applications are generally divided into three components. The presentation logic of the application most often resides on the client, the application logic is typically divided between the client and the server, while the data management layer usually resides on the server. This complicates the design of client-server applications because the entire application needs to be maintained in a known state over the distributed environment namely through several computer systems.

What is needed is a new method and architecture for building reliable and efficient client server applications around a browser that overcomes the limitations inherent in the prior art.

### BRIEF DESCRIPTION OF THE DRAWINGS

The present invention is illustrated by way of example, and not limitation, in the figures of the accompanying drawings, wherein:

FIG. 1 shows a block diagram of a conventional client-side browser interacting with a server to request and retrieve information according to the prior art.

FIG. 2A shows a conventional three-tiered client-server application according to the prior art.

FIG. 2B shows multiple objects held in the three-tiered client-server application of FIG. 2A.

FIG. 3 shows a page for creating a database form on a client-side browser according to one embodiment of the present invention.

FIG. 4 shows an example form created by a user on a client-side browser according to one embodiment of the present invention.

FIG. 5A shows application state variables held in a database table as a component on a server according to one embodiment of the present invention.

FIG. 5B shows how state maintenance is achieved in a practical system using the model of FIG. 5A.

FIG. 5C shows a typical client server interaction showing the process of state information held in the tables.

FIG. 5D shows an extension of the previous model where application code can also reside in tables.

FIG. 5E shows a scalable distributed system employing the methods of state, program code and other types of information held in a common storage space.

FIG. 6 shows a program listing in JavaScript used to create a text box in the design phase of a database form using cookies according to one embodiment of the present invention.

FIG. 7 shows a program routine executed during redrawing of a database form following a “state” change held in a cookie string according to one embodiment of the present invention.

FIG. 8 shows concatenating a cookie variable to hold the form schema and customer information for storage and retrieval from a database on a server according to one embodiment of the present invention.

FIG. 9 shows creating a JavaScript array on a server for use on a client computer according to one embodiment of the present invention.

FIG. 10 is a flow chart showing the creation of a new database form on a client computer using a web browser and submitting the form to a server according to one embodiment of the present invention.

FIG. 11 is a flow chart that shows reconstructing a database form on a server and submitting the form to a client computer according to one embodiment of the present invention.

FIG. 12 is an example of a computer system on which the present techniques can be implemented.

FIG. 13 is a block diagram of a server computer system connected to multiple client computer systems.

### DETAILED DESCRIPTION

The present invention provides a system and method for building a scalable client-server. A unique database application has been built using the methods and processes described. Although well suited for use in database applications, the system and method described may also be extended to include other networked applications using a browser, such as word processor applications, project management, accounting, and resource planning. The system and method is also applicable to any generic based client-server system where the state of a distributed system is known at any point in time. Accordingly, the specification and drawings are to be regarded in an illustrative, rather than a restrictive sense.

Referring now to FIG. 1 there is shown a block diagram of a conventional client-side browser interacting with a server to request and retrieve information according to the prior art. Using a browser 104, a client computer 101 requests a hyper-text transfer protocol (“HTTP”) page 102 from a web server 103 through a network (e.g., the Internet) 109. The client computer 101 includes an operating system 105 and a file system 106. The browser 104 is able to communicate with these systems and also with the web server 103 in a manner known in the art. Once the client computer 101 requests the HTTP page 102, the web server 103 accesses active server pages 107 and/or the database 108 and returns the HTTP page 102 to the browser 104 through the network connection 109. Once this is accomplished, the connection is dropped and the server 103 continues serving HTTP pages in response to client requests.

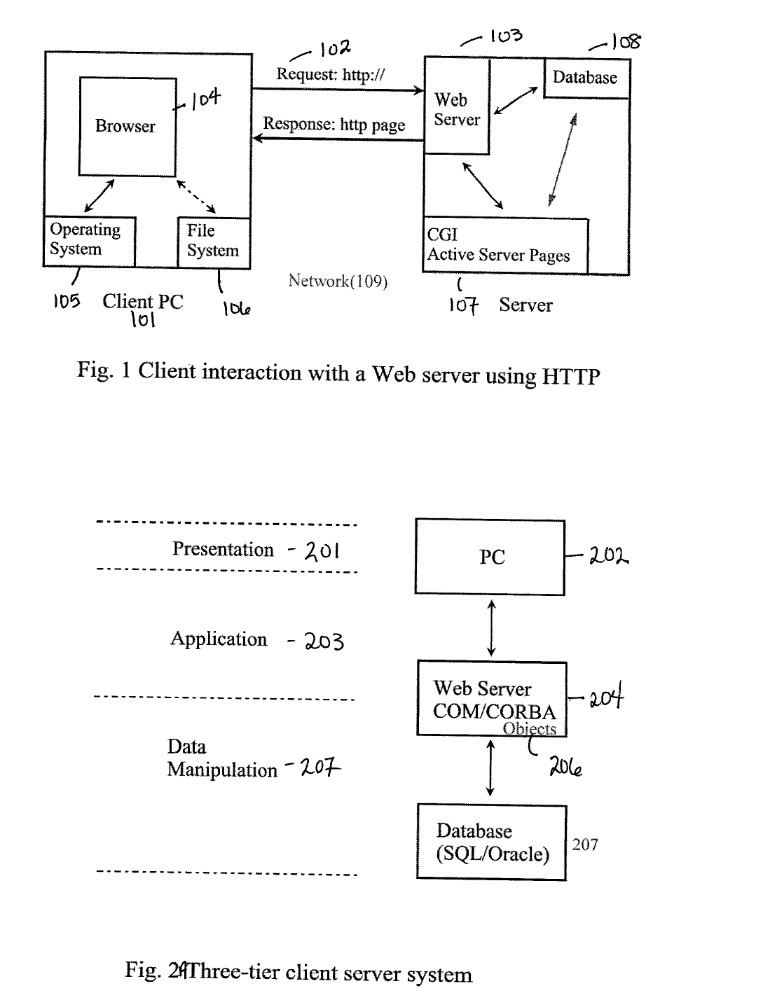

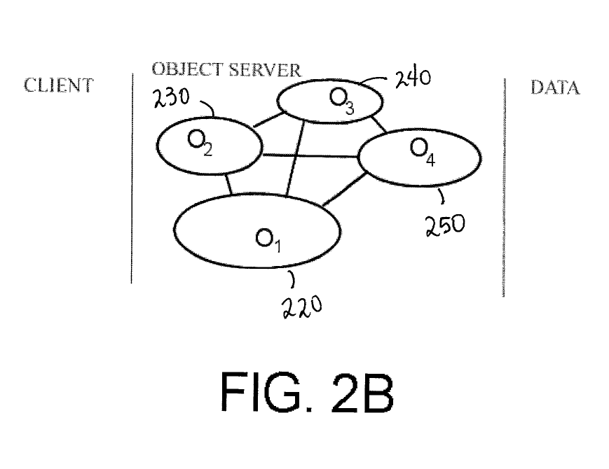

FIG. 2A shows a conventional three-tiered client-server application according to the prior art. The three-tiered client-server application of FIG. 2A divides the client-server into three components. The presentation logic 201 almost always resides on the client 202, the application logic 203 typically resides between the client 202 and the server 204. The format of the application logic 203 held on the client 202 is usually held as an object 206 (software code) made using programming languages such as C++ or Java. In some cases part or all of the application logic 203 can be held in the form of Structured Query Language (“SQL”) procedures well known in the art. These applications typically communicate through proprietary protocol developed by makers of the operating system which gives greater functionality to the client-server than applications using the http protocol such as a browser (thin client). In all cases, the application is considered to be a piece of code operating in its entirety and acts as the middle tier link between the client and the data store. The most widely used architecture have clients perform all of the presentation and some of the application logic where objects are developed in stand-alone fashion and serve as the communication link and intelligence between the client 202 and the data 207.

FIG. 2B shows multiple objects held in the three-tiered client-server application of FIG. 2A. In the typical client-server application there are a number of objects 220, 230, 240, 250, etc., each operating in its own space and being instantiated or destroyed whenever the need arises. These objects 220, 230, 240, 250, etc., perform specific functions depending on the task requested by the user. Because each object performs in its own space, it is difficult to know the state at a specific time unless all objects 220, 230, 240, 250, etc., are interrogated simultaneously and requested to give information about their state.

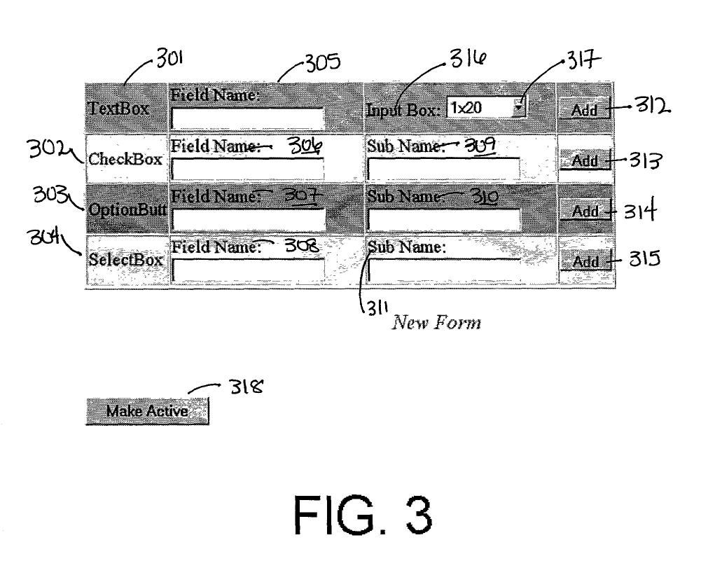

Referring now to FIG. 3 there is shown a page for creating a database form on a client-side browser according to one embodiment of the present invention. In operation, a client user accesses a hyper-text markup language (“HTML”) pages from a HTTP server (not shown in this view). This is generally achieved by entering the uniform resource locator (“URL”) string from the HTTP server in the web browser on the client computer. It should be appreciated that although the network described herein is the intranet, a Wide Area Network (“WAN”), a Local Area Network (“LAN”), or any other system of interconnections enabling two or more computers to exchange information may be used as well. Further, network may include a wireless network, such that one or more computers may operate over a wireless LAN (WLAN).

In the embodiment illustrated by FIG. 3, the page for creating a database form is requested by the client from the web server by accessing the URL (not shown in this view). The form to create the database is contained in this HTML page. To create the application, “cookies” are used to hold application state variables (not shown in this view). Cookies are a mechanism to allow browsers to store information from a specific domain and are often used to hold specific information such as login data, when the site was last visited, etc. The act of using cookies to store specific information coupled to the act of refreshing the client page allows state information to be held on the client side. This allows for the development of dynamic applications without repeated requests from the client to the server. Each time an application variable is stored (i.e., a piece of information of the client form is changed) it is reloaded on the client computer to reflect the change. At the same time the cookie string is also changed to track this change.

For example, if a user adds a Text Box 301 to the form, the form will reload and append this variable to the cookie string. In this manner, cookies are used as storage space much in the same way that random access memory (“RAM”) is used to hold application state in a central processing unit (“CPU”). In one embodiment, JavaScript is used to capture the new form variable and append the new variable to the existing cookie. Of course, perl, Vbscript, PHP, or any other scripting programs that are executable on a browser may also be used. Because all the application logic resides in the HTML page, the client does not need to make repeated requests to the server during the database form creation thus reducing network traffic. The method of cookies storage to hold application state can be extended to include other forms of software containers. This could be in the form of client side arrays where a dynamic storage space can be allocated for holding state information and accessible through client side scripts.

In the example shown in FIG. 3, there are four options the user can use to create a customized database form (i.e., the Text Box 301, the Check Box 302, the Option Button 303, and the Select Box 304). Of course, other template selections (not shown in this view) may be used as well. A user may select the appropriate form type, and enter a Field Name 305, 306, 307, and 308 and a Sub Name 309, 310, and 311 for the form type. By clicking the Add buttons 312, 313, 314, and 315 for the form types, the form type is appended to the end of the form that is being created (i.e., the form is created using cookies storing information relevant to that form on the Text Box 301). Any combination of Text Boxes 301, Check Boxes 302, Option Buttons 303, and Drop-Down list boxes (not shown in this view) can be added in this manner. An input box 316 allows the user to control the size of the record in the database using the scroll down icon 317. When the form is completed, the user clicks the Make Active button 318 to submit the form to the server (not shown in this view) where it is stored for further use. The user can simply access this form to store and retrieve records from the server using a web browser.

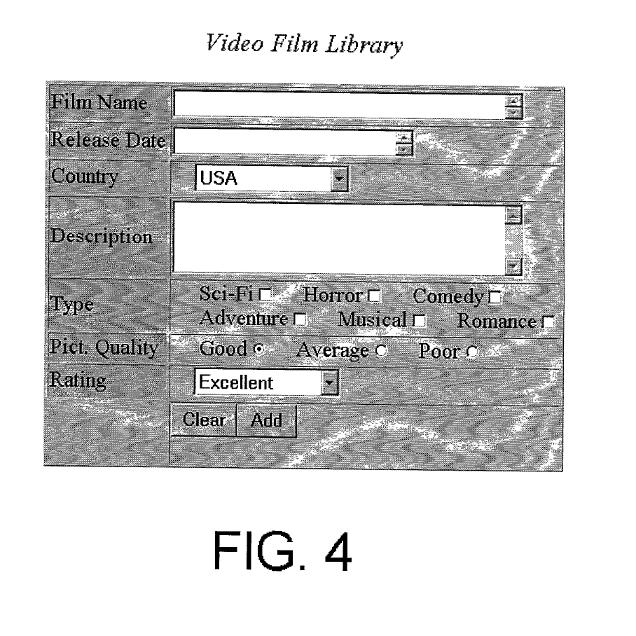

Referring now to FIG. 4 there is shown an example form created by a user on a client-side browser according to one embodiment of the present invention. The form in FIG. 4 is an example video form created using the forms screen of FIG. 3. Of course, a wide variety of forms for storing different types of information may be created using the forms screen. To view a record (such as the record illustrated by FIG. 4), a client request is transmitted to the server and the server sends the appropriate record back to the client. In one embodiment of the invention a user may specify a range of data he wants to look at. The server receives the data range request and packages the data in a JavaScript array (of course, other types of software arrays can be used as well) and then sends this data back to the client where the client can handle it directly without further requests to the server. In addition, JavaScript can be used to perform calculations or analysis of the data through the JavaScript data array. This is an efficient way of retrieving data and placing application logic on the client side that minimizes network usage.

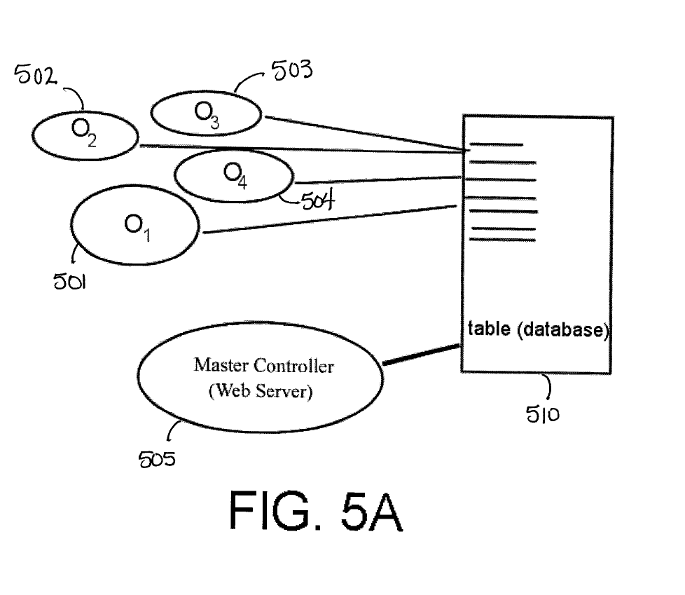

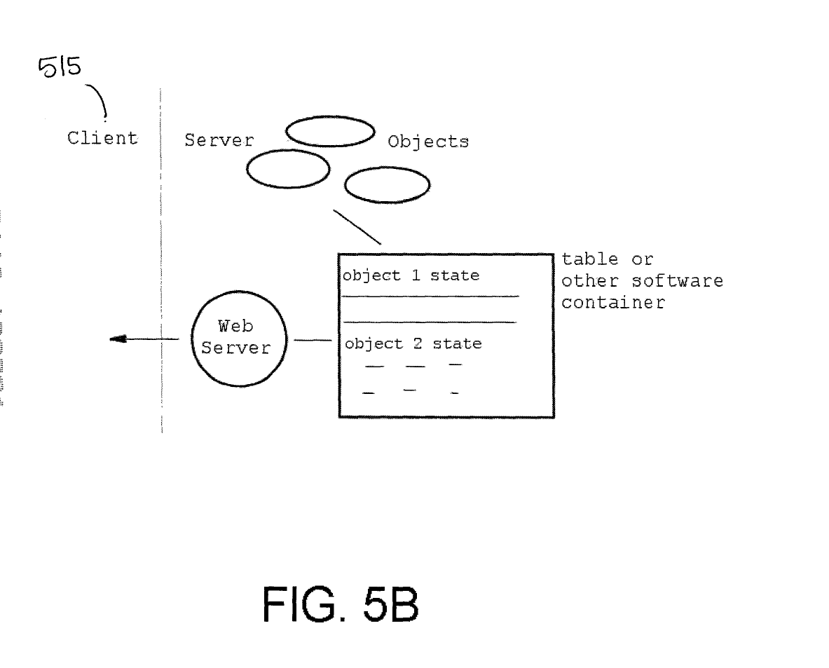

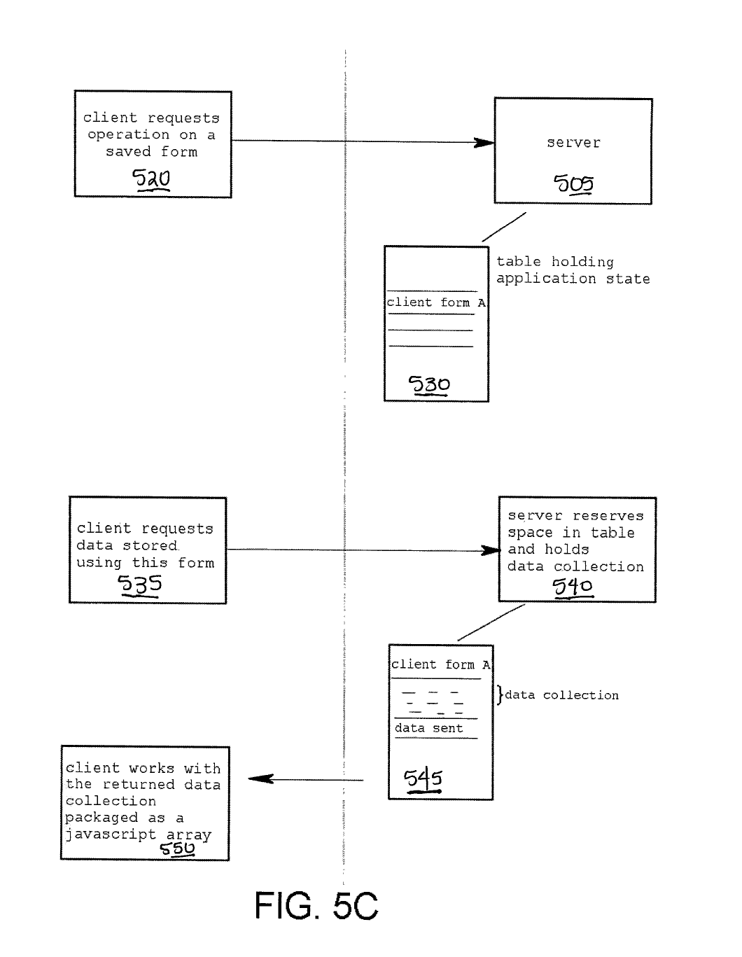

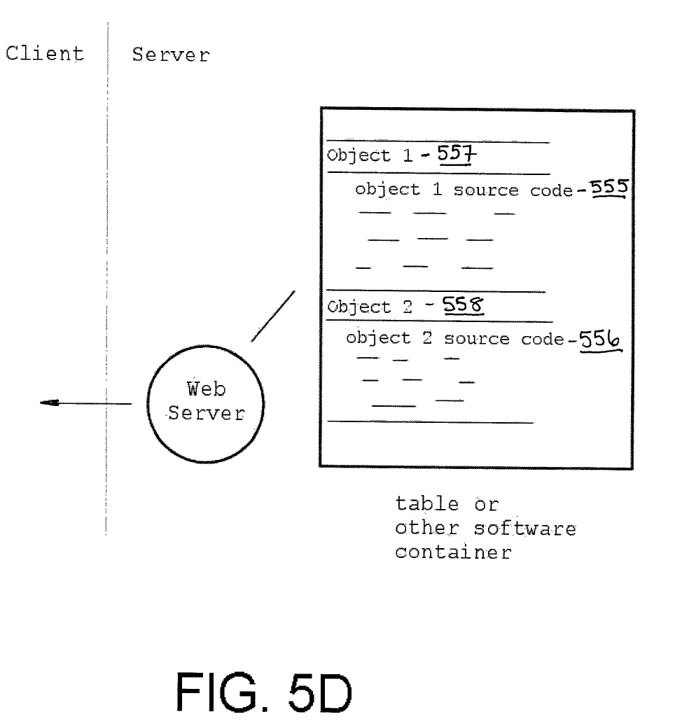

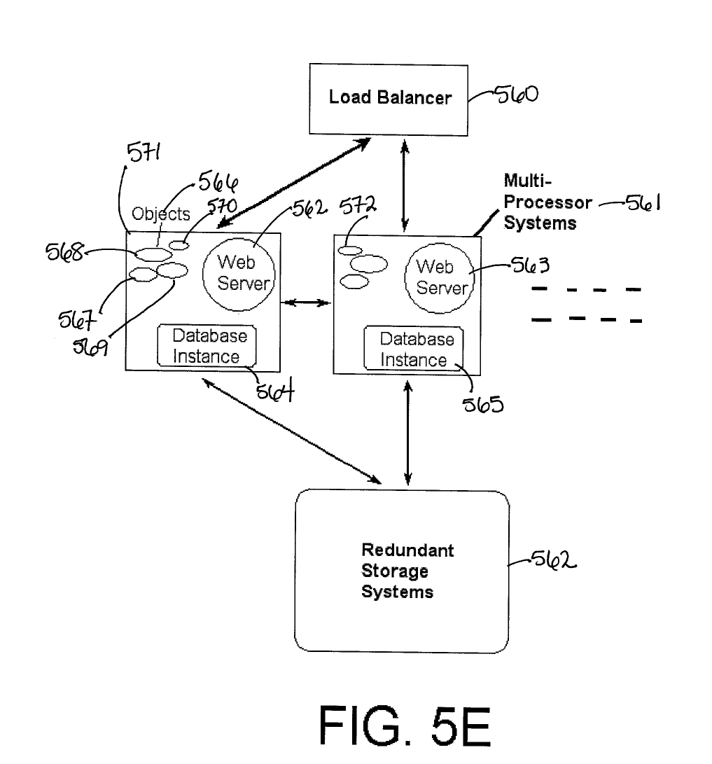

FIG. 5A shows application state variables held in a database table as a component on a server according to one embodiment of the present invention. The architecture illustrated in the embodiment of FIG. 5A makes use of a database table 510 to perform state maintenance. After creating and submitting the form described earlier the client can request to operate on this new form (i.e., add or retrieve information through this form) much like any other database application.

State variables of the application session are maintained through a table held in the database 510 shown in FIG. 5A. Objects 501, 502, 503, 504, etc., are held in table format 510 and then reconstructed on HTML through cookie variables held in a string (not shown in this view). In addition, a master (system) controller (e.g., a web server) 505 oversees and monitors the objects' state by interrogating the table information 510 where the objects 501, 502, 503, 504, etc., hold their state. The objects 501, 502, 503, 504, etc., transmit state information to the table 510, so a snapshot of the distributed environment is always known. When a client requests a form, the server calls up only that string. The string is then reconstructed on the client end (e.g., the JavaScript reconstructs the form using cookies).

FIG. 5B shows an implementation of the model discussed above where the web server handles the objects and state information held in tables or other software containers. A client 515 communicates with the web server via a network (not shown in this view). In the context of the database application, FIG. 5C shows the process of state maintenance using this new model. A client requests a form (processing block 520) from a server (processing block 525). The client's session begins by creating an entry in the table that identifies the client as a user and identifies the form that the client needs to utilize (processing block 530). The client requests stored data using this form (processing block 535). The system reserves sufficient space within the table to allow the retention of state variables within this current session (processing block 540). Once the session has expired (i.e., when the user has finished with the application), the state variables may be archived for future reference (processing block 545) or discarded. The client works with the returned data collection packaged as a JavaScript array (processing block 550). Since databases are only limited by the capacity of the physical drive, the archiving of state information can be very powerful for troubleshooting since the historical state of objects is never lost. As the session progresses, state information is continuously added, updated or deleted within the reserved space for this session.

A second architecture can be realized from the previous model. FIG. 5D shows application codes 555 and 556 residing in the table or other software container in addition to state variables 557 and 558. The code may be executed line by line (interpreted method) whereas the rows in the table can represent each line of code. An object handler may be responsible for the execution of the code. Alternatively, the resident code may be a binary file in which case the table may retain the whole code in the table with a pointer to it. Code may be extracted and executed through the object handler from requests by the web server.

FIG. 5E shows a complete distributed architecture based on these methods. The architecture consists of a load balancer 560, a single middle tier multi-processor (MP) system 561 or 571 and a backend redundant storage system 562 for holding the database. The load balancer 560 redirects client traffic according to the load distribution of the MP systems 561 and 571 and selects the MP system with the minimum load. A web server 562 or 563 responds to the clients' request and pulls the appropriate pages from the storage system. The redundant storage system 562 holds the database and its content to reliably maintain and operate the whole distributed system. This will typically include all object code 566 and 572, web pages and other static and dynamic information related to the system as a whole. A request for an object is made via a web page through the web server 562 or 563. A database instance 564 or 565 pulls the appropriate code from the table in the storage system and is instantiated in the specific MP system 561 or 571. The request made by the database instance 564 or 565 may be in the form of SQL queries and handed back to the web server 562 or 563 for processing. State variables for this object are maintained in the common table and are accessible by any of the MP systems 561 or 571.

Communication between objects between two MP systems 561 or 571 is carried out through the state variables maintained within the common tables. By retaining all relevant information within a database or distributed software container a new level of software abstraction is achieved. The dependence on a specific file system of the operating system is avoided since information is now stored through the common database software component. FIG. 5E illustrates a parallel database that may implement the architecture of the present invention. In addition to using databases, other distributed type of software containers may also be used. The middle tier shown in FIG. 5E are CPU systems where all requests, object instantiation and queries are executed.

A relational database may be used for mapping the file system of an individual machine including other components such as drivers, registry information etc. The storage of application state within the tables is useful in many applications, such as chat. In one example, the chat text between two instantiated objects (two people engaged in a chat) are held in the table and returned to the clients from the table (not shown in this view).

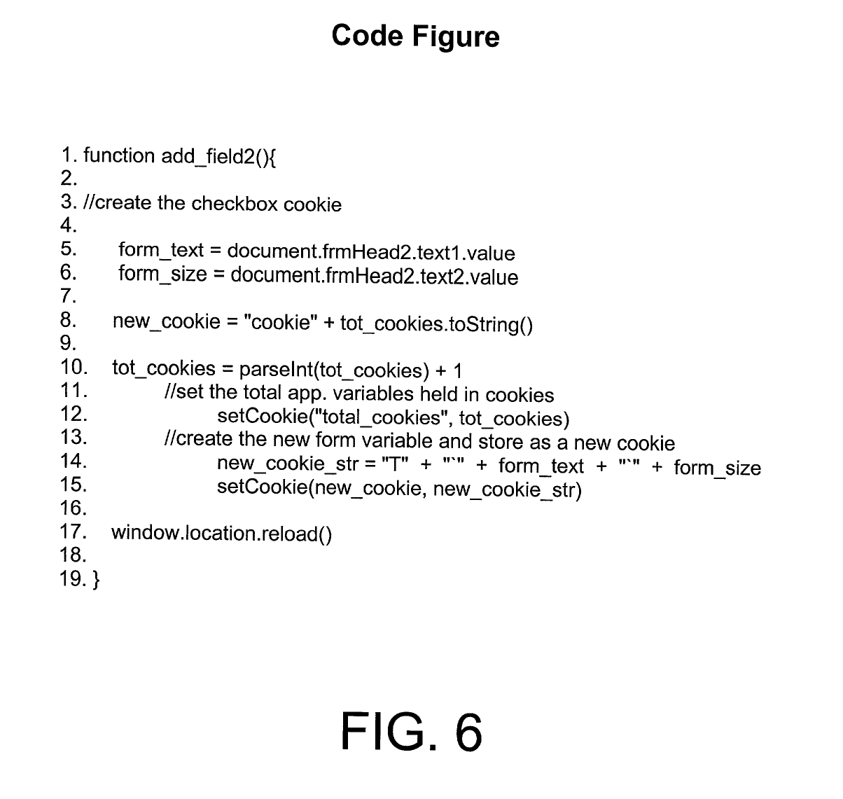

FIG. 6 shows a program listing in JavaScript used to create a text box in a design stage of a database form according to one embodiment of the present invention. Lines 5 and 6 show the values chosen by the user for a Text Box name and Text Box size, respectively. Line 12 increments by one the total number of application variables stored in the cookies. The new cookies variables are created (line 14) and are written to the cookie container of the clients' machine (line 15). Immediately following this step, the browser window is redrawn to include the new Text Box requested by the user (line 17). Repeating this step allows additional form elements to be added. The browser does not make any requests to the server during the design phase and it is only after the form is completed that the information is sent to the server. It should be noted that the steps for deleting a form row are similar to the steps for creating a row except that the total number of cookies (i.e., application variables) are reduced by one.

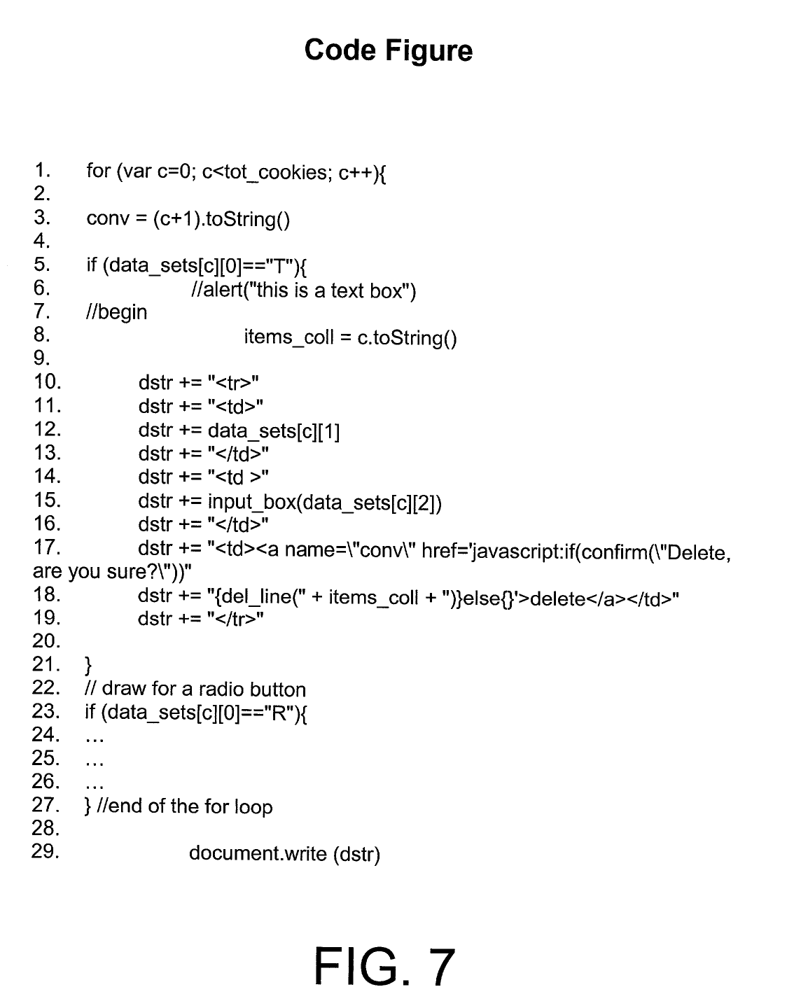

FIG. 7 shows a program routine executed during redrawing of a database form based on new information held in a cookie string according to one embodiment of the present invention. The cookie variables are placed in a two dimensional array (data_sets) for easier handling. Line 1 loops through the cookie variables and builds an HTML string containing the rows of the form. When this is completed, the whole string is written to the client (line 29) to display the new page.

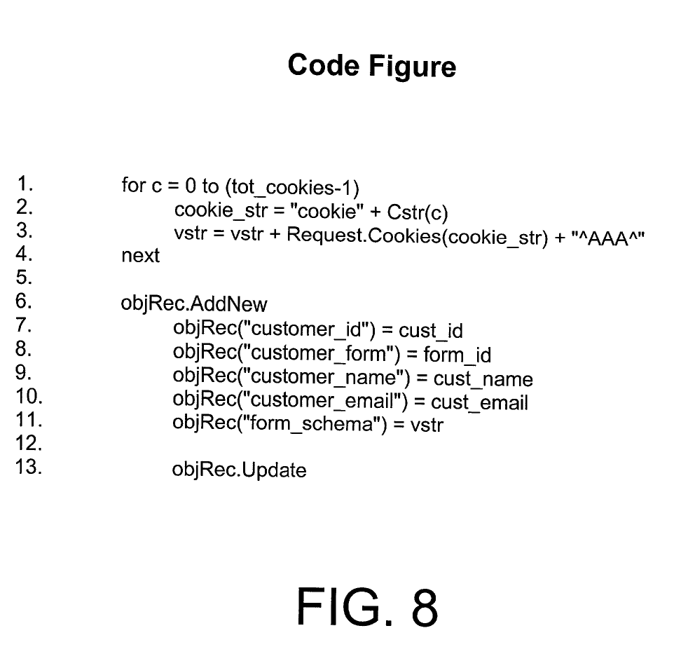

FIG. 8 shows concatenating a cookie variable to create a database form schema according to one embodiment of the present invention. When submitting the new form to the server for storage, the cookie variables are combined into a long string (lines 1-4). The string contains all the information necessary to rebuild this form. The separator ‘ˆ AAAˆ ’ is used to distinguish each of the form elements. Lines 6-13 show the code that inserts the cookie variables along with the users' details into the server database.

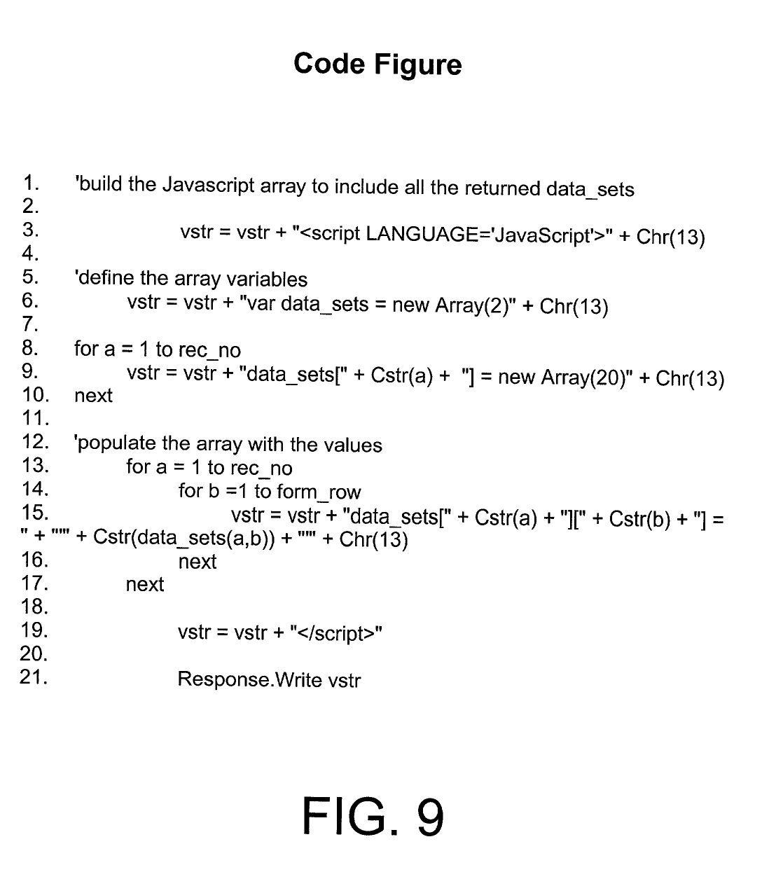

FIG. 9 shows creating a JavaScript array on a server for use on a client computer according to one embodiment of the present invention. As described herein, to add a record a user calls up the form and submits the record to a server where it is stored in a database. To view a collection of records, the user sends the specified data range request to the server. The server-side script retrieves the data from the database and creates the JavaScript array prior to sending it to the client. Data held in the array allows the user to scroll through the collection on the client-side without making repeated requests to the server. For example, the user can click the back and forward keys to scan through the records held in the JavaScript array.

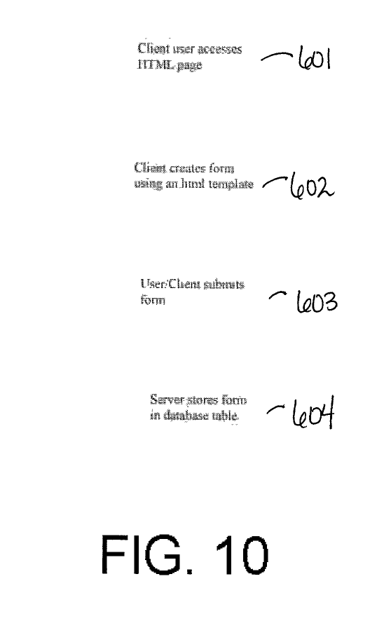

FIG. 10 is a flow chart that shows the steps of creating a new database form on a client computer using a web browser and submitting the form to a server according to one embodiment of the present invention. A client user accesses an HTML page from a server (processing block 601). client user creates a customized database form using the browser by selecting various templates and entering various field names for each record in the database (processing block 602). The user submits the form to the server using the network connection (processing block 603). The server stores the form as a string in a table on the server (processing block 604).

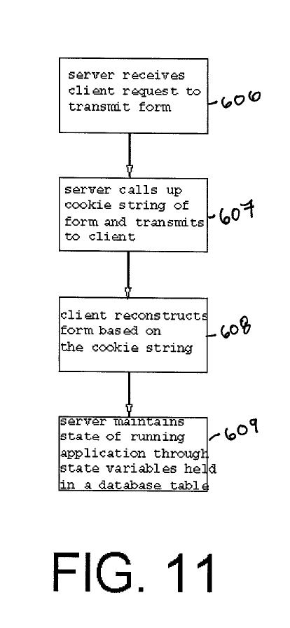

FIG. 11 is a flow chart that shows the steps of reconstructing a database form on a server and submitting the form to a client computer according to one embodiment of the present invention. A server receives a client request to transmit a particular form stored on the server (processing block 606). The server calls up the cookie string holding the application state variables for the particular form and transmits the cookie string to the client computer over the network (processing block 607). The client computer reconstructs the form using cookies (processing block 608). The server maintains the state of the running application through state variables held in a database table (processing block 609).

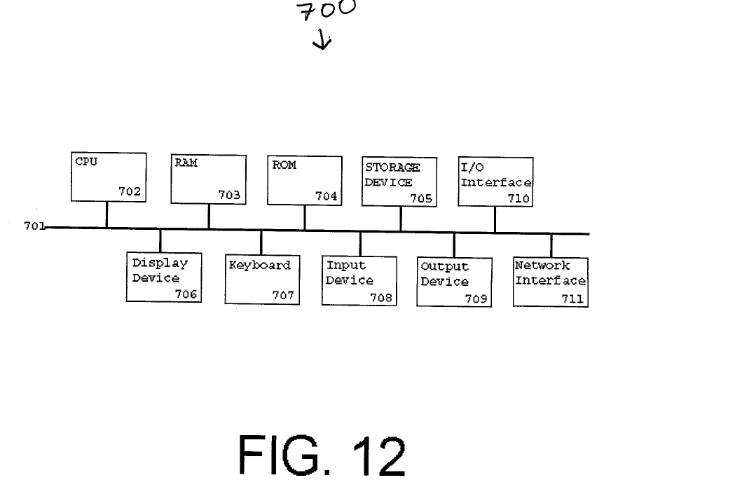

FIG. 12 is an example of a computer system on which the present techniques may be implemented according to one embodiment of the present invention. The computer system 700 includes a processor 702 coupled through a bus 701 to a random access memory (RAM) 703, a read only memory (ROM) 704, and a mass storage device 705. Mass storage device 705 could be a disk or tape drive for storing data and instructions. A display device 706 for providing visual output is also coupled to processor 702 through bus 701. Keyboard 707 is coupled to bus 701 for communicating information and command selections to processor 702. Another type of user input device is cursor control unit 708, which may be a device such as a mouse or trackball, for communicating direction commands that control cursor movement on display 709. Further coupled to processor 702 through bus 701 is an input/output (I/O) interface 710 which can be used to control and transfer data to electronic devices connected to computer 700, such as other computers, tape records, and the like.

Network interface device 711 is coupled to bus 701 and provides a physical and logical connection between computer system 700 and the network medium (not shown in this view). Depending on the network environment in which computer 700 is used, this connection is typically to a server computer, but it can also be to a network router to another client computer. Note that the architecture of FIG. 12 is provided only for purposes of illustration, and that a client computer used in conjunction with the present invention is not limited to this specific architecture.

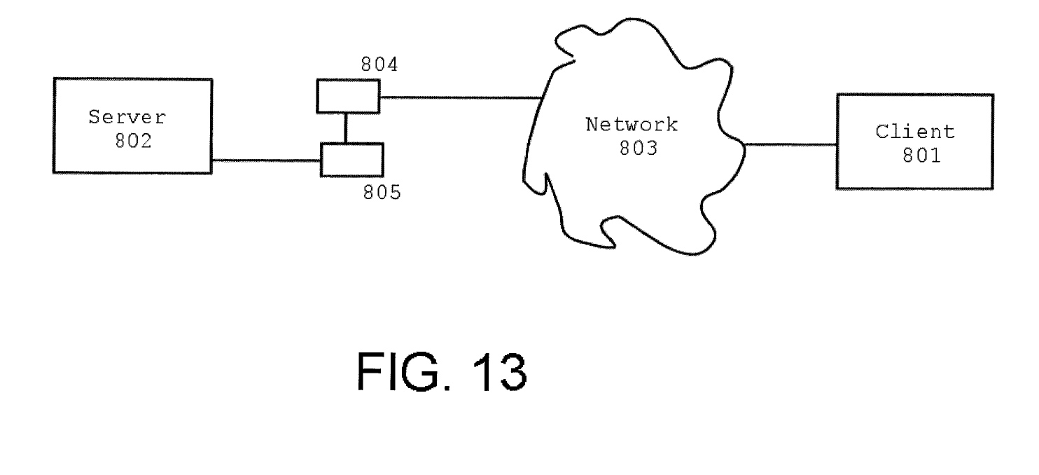

FIG. 13 is a block diagram of a server computer system coupled to a client computer system. Client computer 801 is coupled to a server computer 802 through network 803. The network interface between client 801 and server 802 may also include one or more routers, such as routers 803 and 804, which serve to buffer and route the data transmitted between client 801 and server 802. Network 803 may be the Internet, a Wide Area Network (“WAN”), a Local Area Network (“LAN”), or any combination thereof. Network server 802 contains application programs and/or data that are accessible over the network by other network stations, such as network client 801. In one embodiment of the present invention, network server 802 is a World-Wide Web (“WWW”) server, which stores data in the form of ‘web pages’ and transmits these pages a HTML files over the Internet network 803 to a network client 801. To access these files, network client 801 runs a web browser (not shown in this view), which is simply an application program for accessing and providing links to web pages available on various Internet sites. In a typical Internet client-server environment, the client computer accesses the Internet through a single point of contact, commonly referred to as an Internet Service Provider (ISP) or on-line service provider.

In the foregoing, a system and method has been described for client-based form creation using a browser. Although the present invention has been described with reference to specific exemplary embodiments, it should be understood that numerous changes in the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

I claim:

1. A method of operation for a computer coupled to a network, comprising:
receiving a form description program by the computer over the network;
executing the form description program on the computer to generate a form having a state, the state depending on one or more application program variables that are stored in at least one cookie during generation of the form;
changing an application program variable to a new application program variable; and
refreshing the at least one cookie with the new application program variable to update the state of the form.

2. The method of claim 1 wherein the at least one cookie stores the one or more application program variables in a string on the computer.

3. The method of claim 1 further comprising:
generating a user interface from execution of the form description program; and
selecting one or more templates from the user interface.

4. The method of claim 3 further comprising entering a name on a field of the one or more templates.

5. The method of claim 1 further comprising entering data in the form.

6. The method of claim 1 further comprising:
transmitting the form over the network from the computer to a second computer; and
storing the form on the second computer.

7. The method of claim 6 wherein the one or more application program variables associated with the form are stored in a database table in the second computer.

8. The method of claim 7 wherein the state of the objects is maintained in the database table.

9. The method of claim 8 wherein state queries and interrogation between objects is conducted through the tables.

10. The method of claim 8 wherein software to hold the state of the objects can be any software component including the database table format and software containers.

11. The method of claim 10 further comprising holding application source code in the software component, the application source code accessible by the client through the network.

12. The method of claim 10 further comprising holding the operating system information, the operating system being accessible by the client through the network.

13. The method of claim 7 further comprising accessing the database table by a master controller to obtain state information associated with the objects.

14. The method of claim 7 further comprising transmitting state information associated with the objects to the database table.

15. The method of claim 14 further comprising:
issuing a request over the network by the computer; and
transmitting the form from the second computer to the computer in response to the request.

16. The method of claim 15 further comprising reconstructing the form on the computer.

17. The method of claim 1 wherein the computer receives the form description program from a hyper-text markup language (“HTML”) page stored on a second computer.

18. The method of claim 1 wherein the computer is a client and the second computer is a server.

19. A computer data signal embodied in a transmission medium, comprising:
a code segment including instructions for transmitting to a client system a form description program containing application program variables;
a code segment including instructions for executing the form description program on the client system to generate a form, the application program variables being stored in cookies on the client system; and
a code segment including instructions for transmitting by the client system a version of the form with a new state that includes modified application program variables.

20. The computer data signal of claim 19 wherein the cookies store the application program variables in a string on the client system.

21. The computer data signal of claim 19 wherein execution of the form description program on the client system generates a user interface having templates.

22. The computer data signal of claim 19 wherein the modified application program variables are produced by storing information in one or more fields associated with the templates.

23. The computer data signal of claim 19 further comprising:
a code segment including instructions for receiving by a server system the new version of the form.

24. The computer data signal of claim 19 wherein the application state variables of the new version of the form are stored in a database table as objects on the server system.

25. The computer data signal of claim 19 further comprising:
a code segment including instructions for transmitting the new version of the form from the server system back to the client system.

26. The computer data signal of claim 19 wherein the client system receives the form description program from a hyper-text markup language (“HTML”) page downloaded from a server system.

27. A computer program product comprising:
a computer useable medium and computer readable code embodied on the computer useable medium for causing a transfer of information initiated by a user, the computer readable code comprising:
computer readable program code devices configured to cause the computer to effect the transmitting of a form description program over a communication network to a client machine, execution of the form description program by the client machine generating a form having a state, the state depending on one or more application program variables that are stored in at least one cookie; and
computer readable program code devices configured to cause the computer to effect the receiving, over the communication network from the client machine, a version of the form having a new state that includes application program variables modified by the user.

28. The machine-readable storage medium of claim 27 wherein the at least one cookie stores the application program variables in a string on the client machine.

29. The machine-readable storage medium of claim 27 further comprising:
computer readable program code devices configured to cause the computer to store the modified application program variables in a database table as objects.

30. The machine-readable storage medium of claim 29 further comprising:
computer readable program code devices configured to cause the computer to effect the production of a master controller object to interrogate the database table, state information associated with the objects being transmitted to the database table so as to provide a distributed environment snapshot to the master controller object.

31. The machine-readable storage medium of claim 27 further comprising:
computer readable program code devices configured to cause the computer to effect the transmitting, over the communications network, of the form back to the client machine in response to a request from the user.

32. A computer-readable medium containing a data structure for storing a form, the data structure comprising:
a database table containing a set of application program variables associated with the form stored, the database table storing the set of application program variables as objects; and
a master controller object to interrogate the database table, state information associated with the objects being transmitted to the database table so as to provide a distributed environment snapshot to the master controller object.

33. A method of operation for a computer coupled to a network, comprising:
retaining application states in cookies on a client;
transmitting the application states from the client to the computer over the network; and
storing the states in database tables or software containers on the computer.

34. The method of claim 33 further comprising using an array holder to store the application states.

35. The method of claim 34 wherein the array is accessible using scripting languages on the client.

36. The method of claim 34 further comprising sending data collection from the computer to the client over the network using the array, the array enabling the client to handle the data collection without repeated requests to the client.
